(19) United States
(12) Patent Application Publication
(10) Pub. No.: US 2007/0121866 A1
(43) Pub. Date: May 31, 2007

(54) Method, system and corresponding program products and devices for VoIP-communication

(75) Inventors: Timothy Jay Kniveton, San Francisco, CA (US); Charles Edward Perkins, Saratoga, CA (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/289,202

(22) Filed: Nov. 28, 2005

(51) Int. Cl. H04M 3/42

(52) U.S. Cl. 379/201.1

(57) ABSTRACT

A communication system is disclosed including at least a communication network, one caller party equipped with a communication device by using of which the caller party may originate a communication, one called party equipped with communication means by using of which the called party may response to the communication originated by the caller party and one or more network elements arranged in communication network for arranging the communication between the caller and called parties and which of network elements at least part are arranged to be operated as VoIP system elements in order to arrange VoIP-based communication. In communication system is arranged to be implemented as features a protocol enabling an availability of a presence information of at least the communication means of the called party and an universal designation feature in order to form a destination address for the communication from the caller party to the called party. In the said system in connection with the origination of the communication using of the presence information is arranged to be determined a preferred location of the called party and a data connected to that and based on the determined preferred location of the called party is arranged to be generated the destination address of the called party by using of the universal designation feature and the data connected to the preferred location.

### FIELD OF THE INVENTION

The invention concerns a communication system including at least
a communication network,
one caller party equipped with a communication device by using of which the caller party may originate a communication,
one called party equipped with communication means by using of which the called party may response to the communication originated by the caller party and
one or more network elements arranged in communication network for arranging the communication between the caller and the called parties and which of network elements at least part are arranged to be operated as VoIP system elements in order to arrange VoIP-based communication,
   and in which the communication system is arranged to be implemented as features
a protocol enabling an availability of a presence information of at least the communication means of the called party and
an universal designation feature in order to form a destination address for the communication from the caller party to the called party.

In addition, the invention also concerns method, corresponding program products and communication means.

### BACKGROUND OF THE INVENTION

In traditional communication networks, users contact each other by indicating the address of a specific device the other user possesses. In such a case, for example, a phone number will reference the peer's landline or cellular telephone, an IP (Internet Protocol) address will address the peer's computer, and a SIP URI (Session Initiation Protocol Universal Resource Indicator) will reference a VoIP (Voice over Internet Protocol) phone which has registered with a particular SIP proxy. According to the prior art SIP Calling has always used URIs to indicate the party one wishes to call.

Prior art relating to SIP procedure are described in documents [1] RFC 3216 and [2] RFC 3263. Also, VoIP-/IP- and SIP system elements which are required to implement or initiate a communication in these networks between endpoint parties are well known in the social spheres of the professionals in the field (reference [3]). Thus, the basic features relating to these are not required to describe more particular in connection with this patent application context.

However, the method for contacting another user described above is cumbersome. This is especially due to the fact that it becomes common to carry many communication devices, for example, different device or even a plurality of devices on different moment, and also due to the fact that networks are more densely populated. For one person there may be connected several communication devices. The type of the device may change during a time of day. For example, there may be at least one device on a work hour connected to the user: one device during work hours that has been fixed to some location (office, for example) and one device that has not been fixed to any particular location, at least one device after hours but during the week and at least one device at the weekends or on a vacation. Thus, it is not feasible for end-users to remember their friends' and colleagues' unique endpoint identifiers, and it is even harder to know which of the friend's many devices to dial. This creates a serious user-friendliness problem in many relations. Also, the mobility of the devices complicates the situation in terms of communication costs.

### SUMMARY OF THE INVENTION

The purpose of the present invention is to bring about a way to generate destination address for optimal routing between two communication endpoints. The characteristic features of the system according to the invention are presented in the appended Claim 1 and the characteristic features of the method are presented in Claim 9. In addition, the invention also concerns program products, whose characteristic features are presented in the appended Claims 16 and 20 and also communication device and network element whose characteristic features are presented in the appended Claims 24 and 25.

In the invention is determined and decided the most efficient manner to perform communication between at least two endpoint users in which at least part of the communication is performed based on VoIP-communication. First of all, the invention instructs how to generate the URI (or some other universal designation) of the preferred device of the called party. Secondly, the invention also determines how to route the communication from the caller party to the called party in most economical way through network system by using the generated URI (or some other universal designation). The devices to which the invention relates may be, for example, a SIP device, or a PSTN telephone device having a number identification. Origination of the communication is performed in such a way that the routing of the call will be most efficient and least costly and the called device is also always the most preferred one.

Owing to the invention the user interface is kept simple and intuitive, to facilitate a positive user experience and simplify communication. Furthermore, the invention applies equally well to rich voice calls (with video and/or other data, for example) and takes advantage of the advanced feature sets of IP/PBX products, for example. By the invention special advantage has been achieved in business communication in which there may be several devices connected to one user and in which the enterprise may have several access points for accessing communication between different types of network systems. In addition, the users may also be in different location at each time and this may also be taken into account owing to the invention.

In addition, owing to the invention the caller party may perform determinations in order to determine the most preferred device or devices of the called party. As a keywords of these lookups may be used several kind of keywords/conditions. Owing to this the identification of the called party is not needed to be in the device of the caller party but he or she may retrieve that from the network. In addition to this, always is got the identification of the most preferred current location.

The second improvement achieved with the invention is that the determination of the most preferred location of the called party and the data connected to that may be performed as a routine operation without any human intervention. This simplifies the procedure and there is no need for end-user to understand SIP procedure applying URI and also the network architecture.

In the invention are applied communication elements and features that are mainly known from the prior art as such. However, these elements and features are now combined in such a manner that a several advantages listed above are surprisingly achieved. Some modifications have been performed to these elements and devices in order to perform the routines implementing the invention. According to one embodiment these modifications may be implemented in software level thus requiring no further modifications to the technical features of the elements of devices.

Other characteristic features of the invention will emerge from the appended Claims, and more achievable advantages are listed in the specification.

### BRIEF DESCRIPTION OF THE DRAWINGS

The invention, which is not limited to the embodiments to be presented in the following, will be described in greater detail by referring to the appended figures, wherein

FIG. 1 is a rough schematic view of a basic application example of the system according to the invention,

FIG. 2 is a rough schematic view of a basic application example of the communication device of the caller party and the first program product to be arranged in connection with the communication device of the caller party according to the invention,

FIG. 3 is a rough schematic view of a basic application example of the network element and the second program product to be arranged in connection with the network element according to the invention,

FIG. 4 shows a simplified flowchart of the registration process,

FIGS. 5a and 5b show application examples of the databases according to the invention,

FIG. 6 shows a flowchart of the application example of the method according to the invention relating to determination of the preferred location of the communication device of the called party and

FIG. 7 shows a simplified flowchart of the application example of the method according to the invention relating to the communication between the communication devices of the caller and called party.

### DETAILED DESCRIPTION OF THE INVENTION

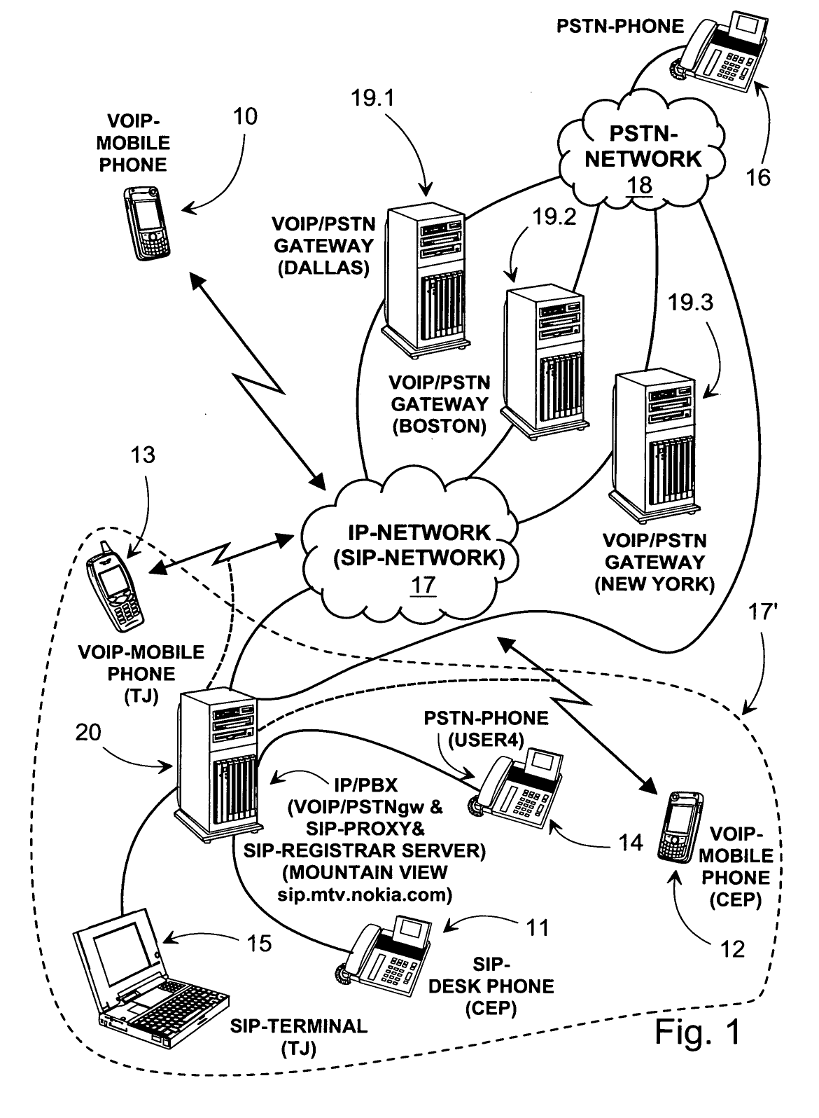

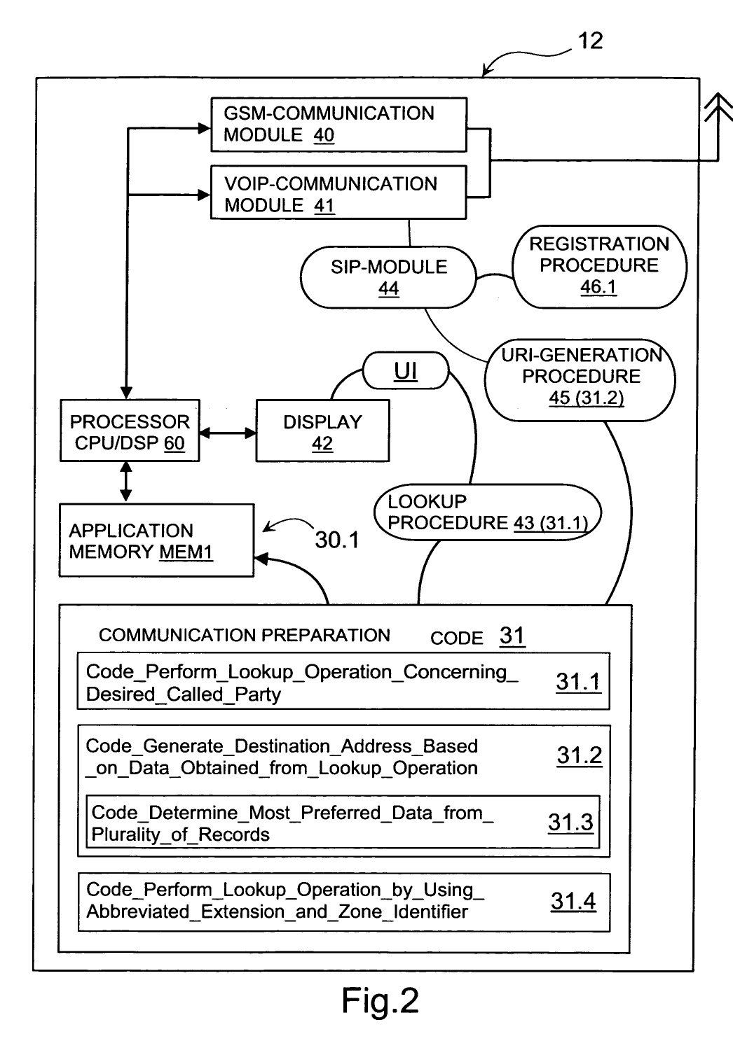

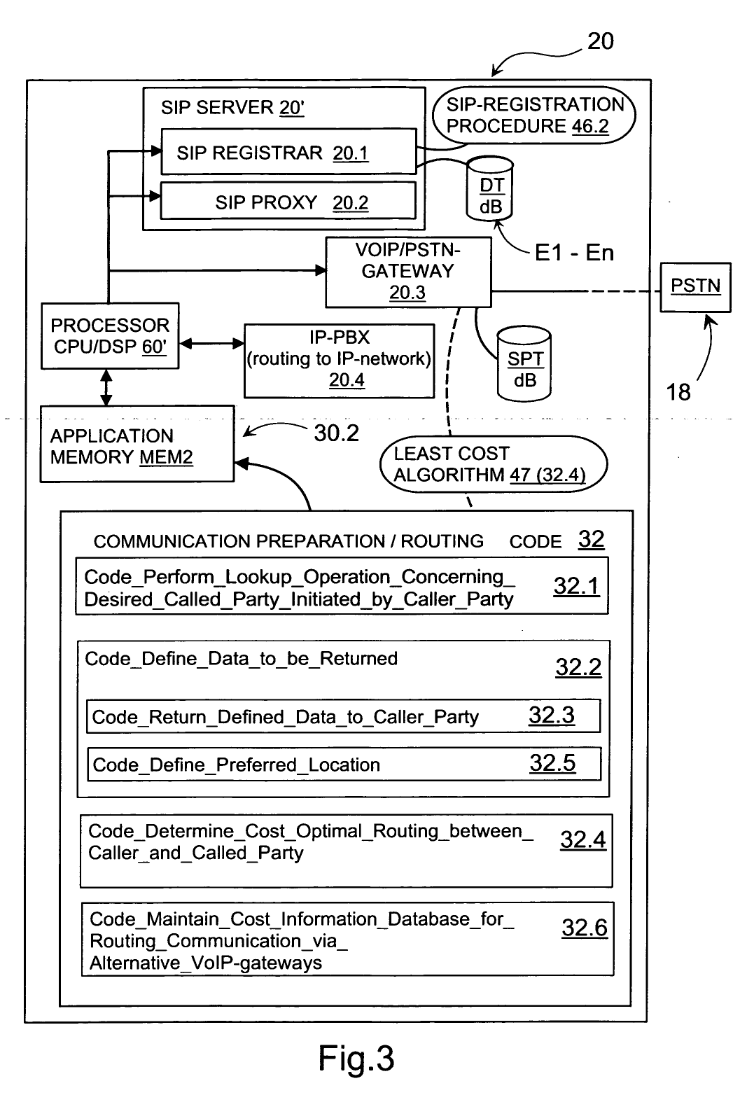

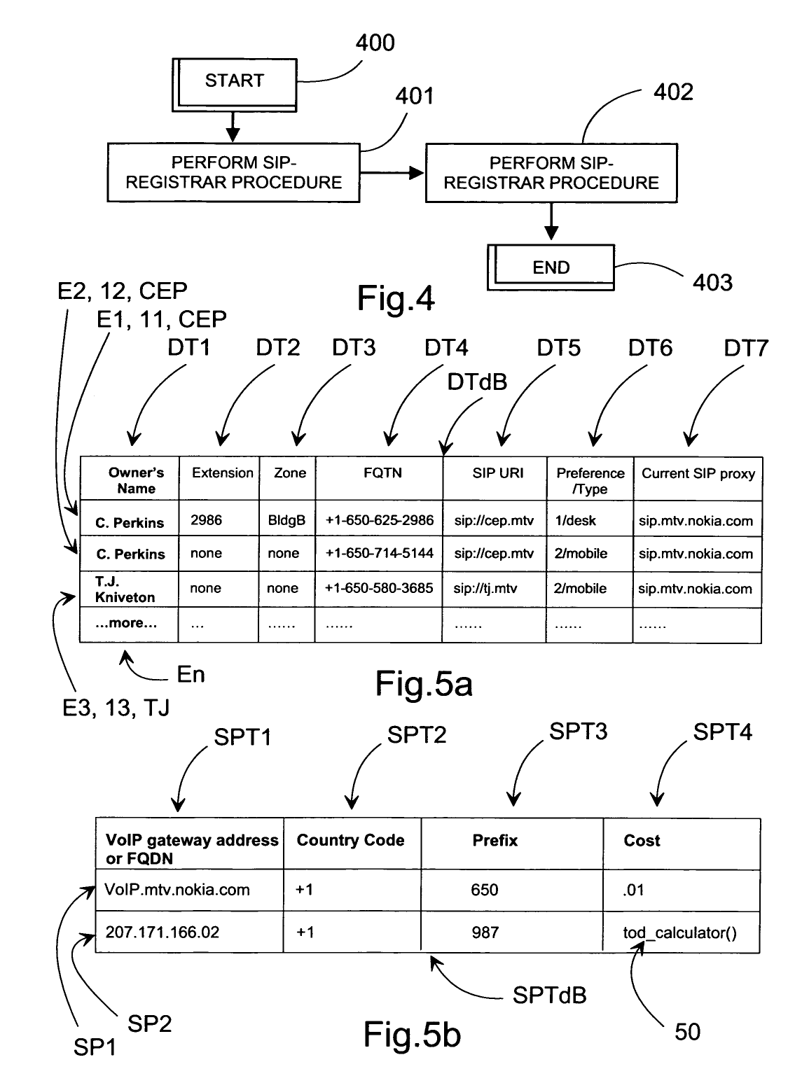

FIG. 1 shows an embodiment of a VoIP based communication system according to the invention. In the next the invention is mainly described based on the system description presented in FIG. 1 but one skilled in the art understands that the system description of FIG. 1 and method description of FIGS. 4, 6 and 7 relates also to the devices according to the invention and, in addition, to program products according to the invention (FIGS. 2 and 3).

In the VoIP system, is a digital data network 17 over which digitized voice signals may be transmitted as a stream of packets (SIP or H.323, for example). The VoIP system according to the invention may include at least a communication network system 17 and one or more functional devices 10-16, 19.1-19.3, 20 arranged in connection with that.

The communication network totality 17 may include one or more sub-networks. The underlying digital data network may be an IP network, for example, the Internet or an Intranet. To the Internet network may be connected private networks 17′ such as one or more Intranet networks. Because the invention is pointed to VoIP communication system, one example of this kind of Intranet network is enterprise's local VoIP system 17′. In such a system 17′ the VoIP calls between parties 11-15 being in the same base location are performed in this internal network system 17′.

To the IP-network system totality 17 there may be connected also other network system totalities. One example of this is a PSTN network 18 (Public Switched Telephone Network). There may be one or more PSTN phones 16 using which communication may be performed with devices connected to the IP-network 17. The VoIP network 17 and the PSTN network 18 are connected to each other using gateways 19.1-19.3 that may be known as such.

To the communication network 17, 17′, 18 there may be connected a plurality of communication devices 10-15, 16 and also, in addition, several kind of network elements 20, 19.1-19.3 which are arrange to organize the communication between these end-user communication devices 10-16 of the networks 17, 17′, 18.

In the communication network 17 there may be at least one caller party and at least one called party. The caller may be equipped with a VoIP communication device 12. However, the requirement of the VoIP feature of the device 12 itself is not necessary. A pure PSTN device without any VoIP features may also be possible. The PSTN device may be connected to VoIP based IP/PBX which then performs the required transformations in order to perform communication based on VoIP. One other example of this device, with or without VoIP features, is a mobile communication device 12, such as, a mobile phone. By using of this device 12 the caller party may at least originate i.e. initiate a communication towards the desired party being also the member in the network system 17, 18. Typically the caller device (or the caller application 31) may be a VoIP device in the enterprise.

In the communication network 17 there may also be at least one called party TJ, USER4. That is also equipped with at least one communication device 13-15, or, in general, communication means. He or she may use that device 13-15 in order to at least response to the communication that is originated by the caller party with his or her device 12 and after that to communicate with that in a well known manner.

Instead of the communication device 11, 13 (a phone) the communication means may include, for example, a voice mail system or a conference call system. Thus, the called party may have different kind of forms of endpoints or systems by means of which the response may be performed or, in general, with which the communication may be performed.

There may also be one or more network elements 20, 19.1-19.3 which are arranged in the communication network 17. The network elements 20, 19.1-19.3 and the basic functionalities and features 20.1-20.4 of them may be also known as such. One network element 20, especially the VoIP element 20, may take care out of even several functionalities 20.1-20.4 required to implement the communication in these networks. These tasks are described later more precisely in the light of the invention.

In general, the network elements 20, 19.1-19.3 are intended to arrange the communication between the communication devices 10-16 of the caller and called parties. At least part of the network elements 20 are arranged to be operated as VoIP system elements in order to arrange VoIP-based communication for at least the VoIP communication device 12 of the caller party. In this connection the expression “arranging the communication” means both arranging the connection between end-point parties and also arranging the actual communication that is performed after the connection has been established. One example to establish connection is to use SIP URI and one example to perform communication is to use some suitable media protocol.

The function of the VoIP/PSTN gateways 19.1-19.3, 20.3 is to arrange the communication between the IP-network 17 and the PSTN network 18 in both directions. They may take care out of, for example, conversions needed to implement this communication, routing of packets and/or codec translation. These gateways 19.1-19.3, 20.3 may be located to different geographical locations. In these locations the PSTN network 18 may be maintained by a different network operator or service provider. This causes that the cost of communication in the PSTN network that is maintained by the particular network operator may vary between geographical areas, for example. By using of the gateways 19.1-19.3, 20.3 it is possible to route the communication from the IP-network 17 to the PSTN network (and in the opposite direction, too) from the selected geographical location i.e. to the PSTN network that is under control of certain network operator. There are presented four VoIP/PSTN gateways 19.1-19.3, 20.3 being in Dallas, in Boston, in New York and in Mountain View. The VoIP/PSTN gateways 19.1-19.3 are described in this connection without any other functionalities but one versed in the art understands that there may and there often is other functionalities in connection with these elements. Instead of that, the network element of Mountain View 20 includes in addition to VoIP/PSTN gateway 20.3 also other functions, too, which are describe to light the invention.

In addition, to the communication system functionalities described above in connection with some of them there may be arranged to be implemented as features a protocol 46.1, 46.2 enabling an availability of a presence information of at least the communication device 11-15 of the called party, an universal designation feature 45 and a determination of a cost of communication 47. All these features 46.1, 46.2, 45 and 47 relate VoIP-systems.

The universal designation feature 46.1, 46.2 is in order to form a destination address for communication from the caller party to the called party. Several universal designation methods may be applied. One example of these is SIP URI (Session Initiation Protocol Universal Resource Identification). To perform tasks relating to this procedure the devices 11-15 and the network element 20 and more particular, its SIP registrar portion 20.1 are equipped with suitable means 46.1, 46.2.

The determination of a cost of communication 47 is in order to determine and decide the-cost optimal routing for the communication between the caller and the called party. This is particularly relevant when the communication is directed to PSTN network 18 i.e. out from the IP-network 17. These three features 46.1, 46.2, 45 and 47 above are generally known and well defined in the prior art. In addition, the implementations of these are not limited in any way to some particular form or location in the network system but skilled person may vary them and their implementation location in the network system greatly.

In the FIGS. 2 and 3 are shown some examples of devices 12, 20 according to the invention. In FIG. 2 is described as a rough example the communication device 12 arranged in connection with the caller party (or called party) and in FIG. 3 the network element 20 including several functions 20.1-20.4 in the same hardware. In general, the caller's VoIP communication device 12 according to the invention may be, for example, a mobile device, such as, for example, mobile phone, PDA device (Personal Digital Assistant), laptop PC or some equivalent intelligent communication device (“smart device”), VoIP or PSTN desk phone. It will have proper means 40, 41 to perform communication, especially VoIP communication, with parties being also in the communication network system. If the device 12 is a mobile phone that may also have properties 40 to perform mobile communication in cellular networks without using packet connected VoIP feature.

In addition, the device 12 may be equipped with processor 60, memory MEM1 and display 42. On the display 42 it is possible to perform user interface UI in order to control function of the device 12. Via the user interface it is possible to control lookup function 43 that is also implement in the device 12.

The device 12 includes also functionalities 44 relating to SIP. In these may be included the registration procedure 46.1 that is already described in the above. SIP module 44 includes also URI generation feature 45 that was also described already in the above.

Within the IP network 17 are a plurality of VoIP gateway servers 20, 19.1-19.3 or in general, servers including one or more functions configured to handle VoIP calls over the IP network 17 and also to perform other tasks relating to these networks and services. In connection with them there may be several functionalities, not only routing/gateway/SIP functions. The plurality of VoIP routing/gateway servers are coupled together, for example, via conventional network routing or other means known by those with ordinary skilled in the art. The VoIP gateway 20, 19.1-19.3 and communication device 12 are equipped with processor 60, 60′ and memory means MEM1, MEM2.

More particular, the server 20 to which the communication devices 11-15 of some user group are connected may be named as a “home server”. The server 20 may include as subfunctionalities or sub-servers such as SIP server 20′ including SIP registrar 20.1 and SIP proxy 20.2, VoIP/PSTN gateway 20.3 and IP/PBX (Private Branch exchange) 20.4 (i.e. IP-based phone switch). Generally speaking, also other media gateways are possible to be applied in connection with the invention.

Generally speaking, the VoIP/PSTN gateway 20.3 may be a gateway that includes hardware, which plugs into the PSTN network. This can be present inside the IP-PBX, such as a line card that plugs into a PSTN line or E-1 (Europe) or T-1 (U.S.) multiplexed PSTN voice lines. It could alternatively be a box in the network, which simply switches the voice traffic to PSTN line(s), but separate from the PBX. Possibilities are not limited some particular when considering that in the light of the basic idea of the invention.

The basic functions and meaning of SIP servers 20′, 20.1, 20.2 are well defined for skilled persons. The function of VoIP gateway 20.3 is also described already in the above. Using that it is possible to route the communication of the local branch 17′ or any other branch having license to use this gateway 20.3 to the PSTN network 18, if appropriate. In connection with server 20 there may also be some databases DTdB, SPTdB relating to the invention and some algorithms 47. These are described more particular in a little bit later.

Next the device 12 and the network element 20 will be described in a manner that is more focused to the invention. For the skilled person, it is well known that the devices 12, 20 may also include other such functionalities, which are not required to describe in this application context more detailed manner. In addition, the function entities of the device 12, 20 described hereinafter can, of course, take care out of many other matters and functions which are considered to be non-relevant to describe in this connection in order to illuminate the basic idea of the invention.

For the skilled person it is obvious that at least part of the functions, operations and measures of the invention may be performed in a program level executed by the processor 60, 60′. Of course, such implementations are also possible in which at least part of the operations are performed on program level and part of the operations are performed on the hardware level. Next in the relevant points are referred to these program code means by means of which the device operations may be performed according to one embodiment.

FIG. 4 shows a simplified flowchart of the registration procedure that is applied in connection with the invention. More particular, the invention applies data that is caused by this registration process. Its purpose is to register active devices 11-15 and their location in the network system 17, 17′, 18.

After start stage 400, in stage 401 the device 12, 13 connected to the VoIP-network 17 performs registration procedure and the SIP server 20′, more particular, its SIP registrar portion 20.1 updates current state of the device 12, 13 in the network system. The server 20′ that may include the SIP register/proxy units 20.1, 20.2 performs presence/connectivity management of the VoIP devices 11-15. It also maintains in its memory a database “Device Table” DTDB. In that is maintained a data relating to devices 11-15 that are currently active in the network 17′, 17 and more particular in the subordination of the local SIP-node 20. One example of this data-base DTdB and its fields DT1-DT7 are presented in FIG. 5a.

The fields of the table DTDB are in this embodiment “Owners name” DT1, “Extension” DT2, “Zone” DT3, “FQTN” DT4, “SIP URI” DT5, “Preference/Type” DT6 and “Current SIP proxy” DT7. For every entry E1-En in the table DTdB, at least one of fields FQTN, SIP URI, or the ordered pair (Ext, Zone) is required.

The field of “Owners name” DT1 may include data relating to the particular person for which the particular device in this entry is dedicated. The data may be, for example, name or nickname of the user. The fields of “Extension” DT2 and “Zone” DT3 may relate to each other. The field “Zone” DT3 may include data relating to a particular location. One example of this zone identification would be the building or local IP/PBX 20.4 to which the particular communication device is connected currently. A zone may be an administratively chosen collection of telephones that are all assigned extensions which only have unambiguous meaning when used in that zone. This kind of device is more like a desk phone than a mobile device that is not fixed to some location. The “Extension” DT2 may be the abbreviated extension from the complete phone number. By using of data provided by the fields of “Extension” DT2 and “Zone” DT3 it is possible to derive the complete phone number FQTN and define the intended device unambiguously.

The next field “FQTN” DT4 is reserved for the complete telephone number including all prefixes and extensions required by that (FQTN, Fully Qualified Telephone Number). It makes possible to call this device anywhere from the network system because it includes all international, area code, regional, and local dialing digits. The next field “SIP URI” DT5 is reserved for Unified Resource Identifier. It makes possible to define the called party at resolution of the SIP proxy 20.2 to which the called party is currently registered.

“Preference/Type” DT6 is a field that gives for the searcher information on the ordering of the best/preferred device on which to contact the peer. It can be updated dynamically by the device (e.g., phone)/web page/location sensing device, or it could be static. The updating procedure of this field may be connected to the SIP registration process that is performed by the devices time to time. This registration is performed without human intervention. The final field in the described device table “Current SIP proxy” DT7 tells the complete name of the SIP proxy 20.2 to which the user is currently registered.

It should be understand that the more dynamic information is updated by SIP operations between the client and its SIP proxy/registrar 20.2, 20.1. Owing to this dynamical character there is always real-time awareness about the current connectivity of the devices and also the servers that are currently handling them (preferred location). The user's preference for which devices are ideal or their telephone number is more static. This is because of that part of the information doesn't change very often.

In general, a reference is made in this connection to SIP standard that may be applied in this connection relating to updating measures performed to device table database DTdB. Registration procedure known from SIP is prior art measure and due to this reason it is no need for its further explanation in this connection.

When the VoIP devices 11-15 are registered to the network system 17, 17′ the content of the database “device table” DTdB may be according to FIG. 5a. It should be noted that only three devices 11-13 are now described in database DTdB.

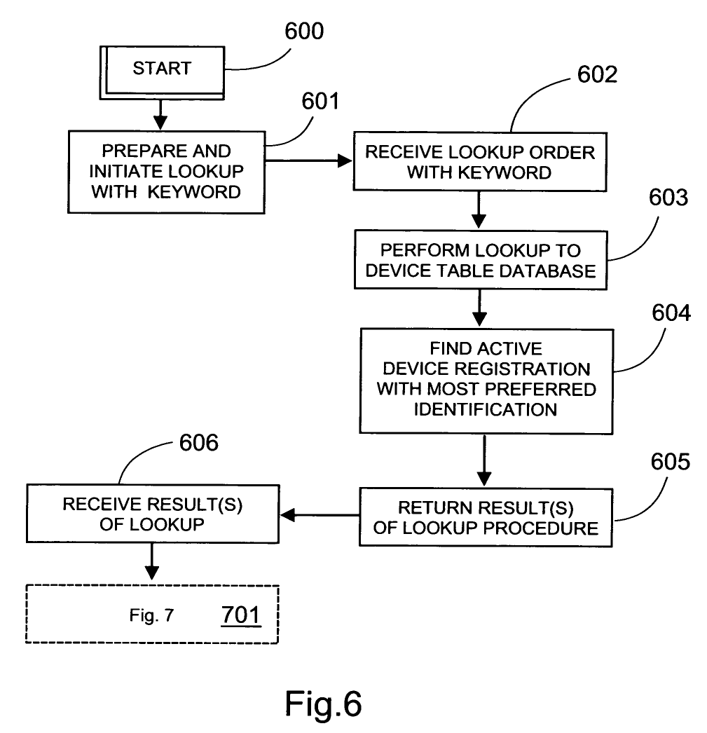

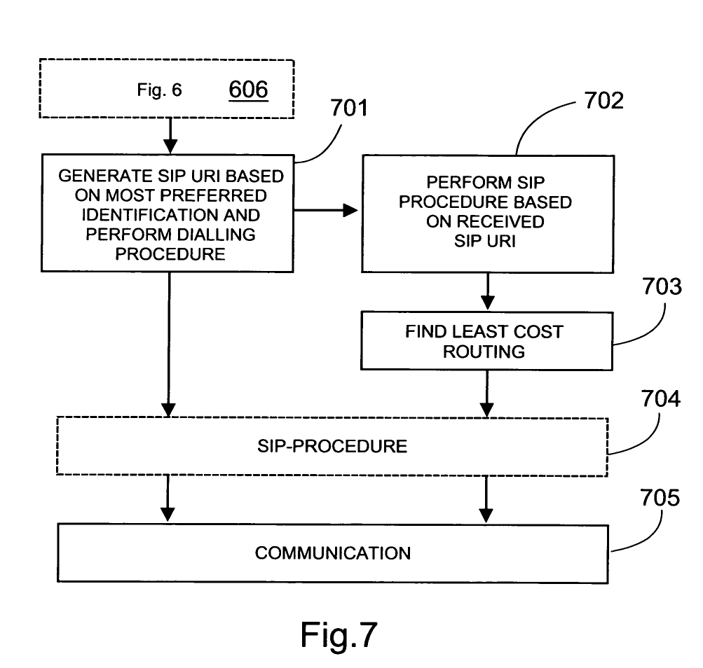

In FIG. 6 is described one embodiment of the method for originating a communication in a communication system in which communication is performed in a communication network 17 that may include one or more sub-networks 17′. In stage 600 the user of the VoIP mobile phone 12 or desk phone 11 wants to originate a call to a particular person TJ that may be an employee of the enterprise and registered to the SIP proxy 20.2 of a particular location (Mountain View). This location may be one of a plurality of locations of the enterprise. This person TJ may have at least one but now in this embodiment several devices 13, 15 to which his identity has been connected.

If the caller party has not the call identification i.e. universal URI of the user TJ available in his device 12 or, although if he would have that in a local phone book or calling log, he would not necessary know the most suitable/appropriate device of a plurality of devices 13, 15 and/or their current connectivity/activity state, he will prepare and initiate a lookup operation over the network in stage 601. By using of lookup that is directed to the network system, more particular, to the server 20 he is going to determine at least one preferred current location of the called party TJ and connection data of at least one communication device connected to one or more preferred locations. In this determination is applied the presence information. Presence information are provided by the SIP proxy server 20.1 or, in general, at least one of the network elements that is equipped with a dynamic presence information database DTdB to which the lookup operation is arranged to be targeted. More particular, according to the invention the presence information is included to the connectivity information that is organized as a certain set of database DTdB on the SIP registrar proxy 20.1 that is described already in FIG. 5a. The implemented feature of the communication system which provides this presence information is the SIP protocol which enables the availability of the presence information of at least the communication device 13, 15 of the called party TJ registered to the SIP registrar 20.1.

The communication device of the caller party is mobile communication device 12 by using of which is performed a lookup operation targeted to the network being now the SIP proxy/registrar server 20.2, 20.1 in order to determine the presence information of at least one communication device of the called party TJ. In order to perform this the mobile communication device 12 of the caller party is equipped with a lookup functionality 43 having some kind of user interface with keyword field(s) and other possible lookup options that are generally known from the prior art of search technology. The lookup may be implement by code means 31.1.

The user of the device 12 have an option to use in the lookup process several kind of keywords which index the lookup by a uniquely identifying key. Some examples of these keywords are, for example, the called party's name or phone number. The user of the device 12 sends a lookup order with the mobile communication device 12 in which the keyword is now the name of the desired called party “T. Kniveton” or at least part of that by using of which the lookup may be performed in the server 20.

The network 17 routes the lookup to SIP server 20 and in stage 602 the server 20 receives the lookup order with the keyword(s). In stage 603 the server 20 performs the lookup to its device database DTdB by using the received keyword “T. Kniveton”. The processor means 60′ of the server 20 and the program code 32 arranged in connection with its memory means MEM2 may process this lookup operation in the database DTdB (code means 32.1).

In stage 604 the server 20 may try to find at least one active registration corresponding the lookup keyword. The measures relating to this may be in the code means 32.2. In this finding process the server 20.1 may first determine the records/entries that correspond the particular keyword “T. Kniveton”. If only one record is found then that is returned in stage 605 to the device 12 that originated the lookup (code means 32.3).

However, if more than one record is found from the database DTdB then it is possible to return them all or again only the most preferred. A second option is to filter the record already on the server 20 (code means 32.5). The analysis for filtering may then be directed to the field named “Preference/Type”. Based on this analysis only the record having greatest priority level is returned (code means 32.3). In this embodiment since, for example, user “C. Perkins” has active registrations (seen in the “current SIP proxy” field DT7) using both devices 11, 12, the lookup procedure would return the ID of the desk phone 11, since it is of priority 1.

More particular, the information included into field DT6 may have form 1/desk, 2/desk, 1/mobile, 2/mobile, etc. In this the number (1, 2) may inform the priority level and the type (desk, mobile) may inform the type of communication device 11-15. The record having smallest preference value is the most preferred to be returned. If performing this filtering from a plurality of devices 11, 12 is avoided unnecessary delivering of the device records to the device 12 initiated the lookup. Also, now it is possible to originate the communication by the device 12 unambiguously because there is no need to perform any determinations or selections of the most preferred device that is the case, if a plurality of records are returned.

Generally speaking, based on lookup performed on server 20, the appropriate records are only returned, and the preferred record will be chosen using preference data DT6 in each record that is processed by a preference determination algorithm arranged in connection with the server 20 (code means 32.2).

Of course, the lookup can also be done based on name, to return multiple devices 11, 12. The favored device 11 can then be selected from the preference field DT6 information. The selection may be performed instead of the server 20 also on the device 12 which has received all records relating to keyword TJ. By this embodiment is achieved advantage in such a case if the keyword has not been so unambiguous that it would only relate to one person. Then it is possible to select the right person on the device 12 by the caller party in order to originate actual communication towards the desired called party. This may be performed by code means 31.3.

In stage 605 the server 20 responds to the lookup operation originated by the device 12 by the returning data relating to the preferred location of the user TJ to which the caller is desired to call. This data may include the record E1 i.e. all data that is in the fields of this record. The device 12 receives in stage 606 the results i.e. one or more records that are found in connection of the lookup process performed in the server 20 on the database DTdB. Then, a step is performed to the actual origination/communication stage described more precisely in FIG. 7.

Some other possible keywords may be beside or alternative for the name, for example, the combination of “Zone” and “Extension” which serves as a unique ID. Also, FQTN or SIP URI would each also serve as a unique ID. A query can be performed on any of these unique IDs, to see which associated devices 11-15 are in use/available and what is their current SIP proxy.

The communication device 11 of the called party may also belong to the sub-network defined by a zone identifier “Zone”. One example of this kind of situation is, if the device 11 is a sub-device in the private network 17′ of enterprise. According to one other embodiment, in the lookup operation may be used as a key an abbreviated extension “Extension” (2986) of the communication device 11 of the called party CEP and in addition a possible zone identifier “Zone” by using of which is defined the zone for the abbreviated extension (BldgB) (code means 31.4).

For instance, according to one embodiment, an external party i.e. now the caller of device 10 might be required to call a published number for access to an enterprise, and then provide an extension number of the called device 11 after the connection to the published number has been completed. Parties internal (devices 12-15) to such a zone can establish telephone connections without the extra step of calling the published number, by simply supplying the desired extension. When no zone information is supplied, the default can be chosen to be the local zone from which the number lookup is processed.

In FIG. 7 is described the initialization of the communication between caller and called party and the communication performed between them that is a logical consequence of the initialization process performed in FIG. 6. It should be noted that the operations relating to lookup procedure described in FIG. 6 are independent from the initiation/originating and actual communication stages, however, the all steps are performed in connection with the origination of the communication.

As already described above, in the communication system is also implemented the universal designation feature 45. This is implemented in order to form a destination address when originating the communication from the caller party to the called party. In stage 701 the device 12 of the caller party will perform generation procedure of the destination address of the called party by using of the universal designation feature 45. In this is applied the data that was received with the device 12 as a result of the lookup procedure presented in FIG. 6. This data is based on the determined preferred current location of the called party TJ and it includes data using which it is possible to form destination address using SIP URI. After generation is performed dialling procedure by using the generated SIP URI.

When the preferred record is chosen, it will be possible to choose a URI (i.e., VoIP/SIP-based, or VoIP->PSTN using most appropriate i.e. now the cheapest gateway), since each record E1-En contains data allowing the construction of a SIP URI (phone IP address or extension and currently registered SIP proxy), or a FQTN that can also be transformed into a SIP URI.

The URI is generated in stage 701 and the sub-stages after that will be performed based on SIP procedure known from prior art (not shown). In this procedure is used INVITE, RINGING, OK, ACK etc. messages (not shown).

The URI syntax may have one of two possible variations. First of these may be a sip:// and the second may be phone://fqtn. The first is an URI as specified for use by SIP clients and servers/proxies. The first of these has still two possible forms. First of these forms is sip://peer-IP-address and the second is sip://URI. In the second form is needed the location of the called device 13 at the resolution of the SIP proxy 20.2.

If the second variation of SIP URI is applied then it is used the fully qualified telephone numbers (FQTN). In that case the syntax that is generated by function 45 may have a form of sip://fqtn@local-VoIPgw. In general, this SIP URI generation procedure may be take care out of code means 31.2 arranged in the device 12

In stage 702 the local server 20 of the device 12 i.e., for example, now the VoIPgw (Voice over IP gateway) 20.3, which also now provides the functionality of a SIP proxy server 20.2 and/or registrar 20.1, intercepts the URI generated in stage 701 by the device 12.

According to the invention the VoIP gateway 20.3 also determines how to route the call over IP-network 17 to another gateway 19.1-19.3, or connect it to the PSTN locally by itself (this may be set to be as the default action). This decision is made by a least-cost-routing algorithm 47 according to the invention (code means 32.4). Now in the communication system is implemented as a feature a determination of a cost of communication in order to decide the cost optimal routing for the communication between the caller and the called party. The VoIP gateway server 20.3 and IP/PBX server 20.4 perform that routing procedure based on stored data related to, for example, the enterprise's VoIP locations 19.1-19.3 and local call costs in each VoIP location 19.1-19.3. The VoIP gateway 20.3 may be quite likely to actually be a SIP registrar/proxy 20.1, 20.2, with PSTN gateway hardware in the same server 20. One skilled in the art understands that VoIP gateway server 20.3 and IP/PBX may be the same entire device. There may also be media gateway controlling functionalities which may take care out of tasks characterized for that (not presented).

For case in which is applied as a SIP URI the format sip://peer_IP-address, the VoIP gateway server 20.3 might not even get involved at all to the relaying of the communication. In that case the communication may be routed direct through IP/PBX 20.4 which routes that to IP network 17. If the called device is directly connected to IP network any VoIP/PSTN gateways need not apply but the communication may performed only in IP network 17. In that case the handset might go directly end-to-end. For this reason, the applying of the least cost data and algorithm 47 is optional.

For case in which is applied as a SIP URI the format sip://URI, the VoIP gateway server 20.3 would act like a SIP proxy, perhaps with additional features for call setup and management sip.mtv.nokia.com. For case, in which is applied as a SIP URI the format sip://fqtn@local-VoIPgw, the VoIP gateway server 20.3 may tunnel the packet to the appropriate PSTN media gateway 19.1-19.3.

Another useful database which may also be applied in connection with the invention is the “site-prefixes” table presented shortened in FIG. 5b. More general, the system includes as the network elements several alternative VoIP gateways 19.1-19.3, 20.3 for routing the communication between the caller and the called parties in an established manner. The device 12 of the caller party CEP is registered to one of the VoIP gateways 20.3 at each moment. In connection with VoIP gateway 20.3 is maintained a second database SPTDB to which is arranged the cost information SPT1-SPT4 for routing the communication from caller party CEP to called party by using the each of the VoIP gateways 20.3, 19.1-19.3. Database SPTDB that may be updated dynamically by processor means 60′ of the server 20 (code means 32.6).

Site-prefixes table is defined as a “complete” database, but procedurally not necessarily most frequently searched database. Occasional preprocessing is likely to be performed to produce a much shorter table SPTdB, with the same fields, but with many records deleted. This caused by the fact that their cost structures make them prohibitive compared to other alternatives. This preprocessing can potentially be modeled as creating a new database view with database consistency constraints.

The derived “site prefixes” database SPTDB is may also be called the “searchable” database. The preprocessing may typically be dependent on local parameters per site, as perhaps negotiated with local service providers for night-time rates or other conditions.

Each record SP1, SP2 . . . states the cost in field SPT4 (or gives data allowing the computation of the cost being, for example, an algorithm 50) on a per-minute or other basis, for calling from a given VoIP gateway to a particular country-code plus prefix. In the first field SPT1 is identified the VoIP gateway or FQDN (Fully Qualified Domain Name). In the absence of data on a prefix field SPT3, the cost is taken to apply to all prefixes in the country-code field SPT2. If no record is returned for the routing algorithm 47 of the server 20.3, the phone call would by default be routed using the local VoIP gateway 20.3. In order to this gateway selection the device 12 of the caller party needs to know what zone it is current in, e.g. by a Service Location Protocol, Router Advertisement extension, or by using some other method.

For instance, a telephone call placed in Mountain View for a party in San Diego (PSTN phone 16, for example) would never be placed through the gateway located in Beijing, so there is no point in keeping records about the toll cost from Beijing to San Diego in the searchable database SPTDB in Mountain View 20.

So, in stage 702 the local server 20.3, 20.4 on the area of which the caller device 12 is located determines the cost effective routing. It defines from the database SPTdB the cheapest route for communication to the called device, for example PSTN phone 16. After this determination process the communication between the caller party and the called party is first routed in IP-network 17 to the determined VoIP gateway which then routes the communication to PSTN network 18. The gateway may be one of the gateways 19.1-19.3, 20.3 dedicated for the users of the enterprises thus allowing the routing of the communication for the particular user. If the called device is VoIP device 10-15, then the least cost routing determinations are not necessary.

After most optimal routing stage 703 and SIP procedure stage entity 704 one or more network elements are used to arrange VoIP-based communication for the VoIP communication devices 12, 13 of the caller party CEP and called party TJ that is also equipped with at least one communication device responding to the communication originated by the caller party. The communication is performed in stage 705 in some manner known from prior art.

The system according to the invention may be implemented with one or more highly reliable databases (such as those manufactured by Oracle, Sybase, and other companies, or an open-source database such as MySQL). This database DTdB may store the information pertaining to the user directory entries, as well as current registration information by using of which is decided most appropriate routing, for example.

The invention is possible to be implemented in mobile terminals (i.e. cellular phones, WLAN SIP Phones, or other handheld devices), which use IP to communicate with a server 20. A lookup query could be performed directly from the handset, or from an intermediary proxy, to a database DTdB which stores the information as detailed in the system description above. Once one or more records are returned from the database DTdB to the processor 60′ of the server 20 or to the processor 60 of the device 12 of the caller party and the correct one selected, the proxy server 20 (or the handset 12 itself) would calculate the preferred record and generate a URI from that information being in the record and corresponding the most preferred and current location of the called party. Then, the handset 12 would use the URI to place a phone call that would be routed to the appropriate SIP proxy of the called party (=pure IP routing) or PSTN gateway 19.1-19.3 using normal SIP and IP routing (=combined IP and PSTN routing).

The determination of the preferred location and the contact data connected to that location and also the generation of the destination address are implemented in the communication device of the caller party as a matter of routine without human intervention. Owing to this is achieved very user-friendly manner to initiate communication between end-point parties. The user of the caller device need not necessary know anything about SIP URI generating processes or even the possible devices of the called party. Also, no knowledge is needed to decide cost optimal routing that is now determined by the network element. Owing to the invention the user experience of VoIP communication will become better.

In FIGS. 2 and 3 is presented rough schematic views of application examples of a program products 30.1, 30.2 according to the invention. The program products 30.1, 30.2 are intended to perform preparing operations in order to deal out VoIP-based communication with a VoIP communication device and to provide VoIP-based communication service in a network element 20. The program products 30.1, 30.2 may include a storing means, such as, a memory medium MEM1, MEM2 and also a program codes 31, 32 executable by the processor unit 60, 60′ of the devices 12, 20 and written in the memory medium MEM1, MEM2 to allow communication in accordance with the method of the invention at least partly in the software level. The memory mediums MEM1, MEM2 for the program codes 31, 32 may be, for example, a static or dynamic application memory of the device 12 or server 20, wherein it can be integrated directly in connection with the communication application or more specifically in connection with the VoIP communication application 41, 20.3.

The program codes 31, 32 may include several code means 31.1-31.4, 32.1-32.4 described above, which can be executed by processor 60, 60′ and the operation of which can be adapted to the method descriptions just presented above. The code means 31.1-31.4, 32.1-32.6 may form a set of processor commands executable one after the other, which are used to bring about the functionalities desired in the invention in the equipment 12, 20 according to the invention. The invention does not have major impact on the implementation details of VoIP communication function 41. The implementation details depend on the product.

It should be understood that the above specification and the figures relating to it are only intended to illustrate the present invention. Thus, the invention is not limited only to the embodiments presented above or to those defined in the claims, but many various such variations and modifications of the invention will be obvious to the professional in the art, which are possible within the scope of the inventive idea defined in the appended claims.

### REFERENCES

[1]: SIP: Session Initiation Protocol, June 2002 http://www.ietf.org/rfc/rfc3261.txt,
[2]: Session Initiation Protocol (SIP): Locating SIP Servers, June 2002, http://www.ietf.org/rfc/rfc3263.txt
[3]: voip-info.org, web browsing possible at least 10/2005, http://www.voip-info.org/wiki/

What is claimed is:

1. A communication system including at least
a communication network,
one caller party equipped with a communication device by using of which the caller party may originate a communication,
one called party equipped with communication means by using of which the called party may response to the communication originated by the caller party and
one or more network elements arranged in communication network for arranging the communication between the caller and called parties and which of network elements at least part are arranged to be operated as VoIP system elements in order to arrange VoIP-based communication,
and in which communication system is arranged to be implemented as features
a protocol enabling an availability of a presence information of at least the communication means of the called party and
an universal designation feature in order to form a destination address for the communication from the caller party to the called party,
characterized in that in the said system in connection with the origination of the communication
using of the presence information is arranged to be determined a preferred location of the called party and a data connected to that and
based on the determined preferred location of the called party is arranged to be generated the destination address of the called party by using of the universal designation feature and the data connected to the preferred location.

2. System according to claim 1, characterized in that in communication system is arranged to be implemented as a feature a determination of a cost of communication in order to decide the cost optimal routing for the communication between the caller and the called party and based on the generated destination address is arranged to be determined the cost optimal routing for the communication between the caller and the called parties.

3. System according to claim 1, characterized in that the communication device of the caller party is a mobile communication device.

4. System according to claim 1, characterized in that the device of the caller party is equipped with a lookup functionality in order to determine the presence information of at least one communication means of the called party from the network and at least one of the network elements is equipped with a dynamic presence information database to which the lookup operation is arranged to be targeted and a processor for performing the lookup.

5. System according to claim 1, characterized in that the lookup operation and origination of the communication are arranged to be performed as independent operations.

6. System according to claim 1, characterized in that the determination of the preferred location and data connected to that and the generation of the destination address are arranged to be implemented in the communication device of the caller party as a matter of routine without human intervention.

7. System according to claim 1, characterized in that the communication means of the called party is arranged to belong to a sub-network defined by a zone identifier and in the lookup operation is arranged to be used as a key an abbreviated extension of the communication means of the called party and in addition the possible zone identifier by using of which is arranged to be defined the zone for the abbreviated extension.

8. System according to claim 1, characterized in that the system includes as the network elements several alternative VoIP gateways for routing the communication between the caller and the called parties in an established manner and to which one of the VoIP gateways the device of the caller party is registered at each moment and in connection with that VoIP gateway is arranged to be maintained a second database to which is arranged the cost information for routing the communication from the caller party to the called party by using the alternative VoIP gateways.

9. Method for originating a communication in a communication system in which the communication is performed in a communication network and in which method
a caller party equipped with a communication device originates a communication,
one or more network elements are used to arrange a VoIP-based communication and
a called party equipped with communication means responses to the communication originated by the caller party and ps in which communication system is implemented as features
a protocol enabling an availability of a presence information of at least the communication device of the called party and
an universal designation feature in order to form a destination address for the communication from the caller party to the called party,
characterized in that in the method in connection with the origination of the communication
using of the presence information is determined a preferred location of the called party and a data connected to that and
based on the determined preferred location of the called party is generated the destination address of the called party by using of the universal designation feature and the data connected to the preferred location.

10. Method according to claim 9, characterized in that in communication system is implemented as a feature a determination of a cost of communication in order to decide the cost optimal routing for the communication between the caller and the called party, and based on the generated destination address is determined the cost optimal routing for the communication between the caller and the called parties.

11. Method according to claim 9, characterized in that the caller party is performed a lookup operation targeted to the network in order to determine the presence information of at least one communication means of the called party and to which lookup operation at least one of the network element is responded by returning data relating to the preferred location.

12. Method according to claim 11, characterized in that the lookup operation and the origination of the communication are performed as independent operations.

13. Method according to claim 9, characterized in that the determination of the preferred location and the data connected to that and the generation of the destination address are implemented in the communication device of the caller party as a matter of routine without human intervention.

14. Method according to claim 9, characterized in that the communication means of the called party belongs to a sub-network defined by a zone identifier and in the lookup operation is used as a key an abbreviated extension of the communication means of the called party and in addition the possible zone identifier by using of which is defined the zone for the abbreviated extension.

15. Method according to claim 9, characterized in that the system includes as the network elements several alternative VoIP gateways for routing the communication between the caller and the called parties in an established manner and to which one of the VoIP gateways the device of the caller party is registered at each moment and in connection with that VoIP gateway is maintained a second database to which is arranged the cost information for routing the communication from caller party to the called party by using the alternative VoIP gateways.

16. Program product for performing preparing operations in order to perform VoIP-based communication with a communication device, which program product includes a storing means and a program code executable by a processor and written in the storing means, characterized in that the program code includes
first code means configured to perform a determination in order to determine a data relating to a preferred location of communication means of a called party and
second code means configured to generate a destination address of the called party based on the determined preferred location of the called party by using of the universal designation feature and the data connected to the preferred location.

17. Program product according to claim 16, characterized in that the program code includes additionally third code means configured to determine the preferred location of the called party by using of a plurality of the presence information.

18. Program product according to claim 16, characterized in that the program code is configured to implement the determination of the preferred location and the data connected to that and the generation of the destination address in the communication device of the caller party as a matter of routine without human intervention.

19. Program product according to claim 16, characterized in that the said determination operation is a lookup operation and the program code includes additionally fourth code means configured to use as a key in the lookup operation an abbreviated extension of the communication means of the called party and in addition a possible zone identifier by using of which is arranged to be defined the zone for the abbreviated extension.

20. Program product for providing VoIP-based communication service in a network element, which program product include a storing means and a program code executable by a processor and written in the storing means, characterized in that the program code includes
first code means configured to perform lookup operations initiated by a communication device of a caller party and concerning a called party and in which lookup operations is applied data provided by a protocol enabling a presence information availability of at least the communication means of the called party,
second code means configured to define a data of the called party to be returned and
third code means configured to return the defined data of the called party to the communication device of the caller party.

21. Program product according to claim 20, characterized in that the program code includes additionally fourth code means configured to determinate the cost optimal routing for the communication between the caller and the called party.

22. Program product according to claim 20, characterized in that the program code includes additionally fifth code means configured to determine a preferred location of the called party by using of the determined presence information and a data connected to the preferred location.

23. Program product according to claim 20, characterized in that the program code includes additionally sixth code means configured to maintain a second database to which is arranged the cost information for routing the communication from the caller party to the called party by using alternative VoIP gateways.

24. A communication device by using of which the caller party may originate a VoIP-based communication to communication means of a called party and which communication device is equipped with an universal designation feature in order to form a destination address for the communication from the caller party to the called party, characterized in that the communication device is equipped with
a lookup feature in order to determine a preferred location of a communication means of the called party and a data connected to that by using of the presence information provided by the network system and
a generation feature in order to generate the destination address of the called party by using of the universal designation feature which destination address is based on the data obtained from the determination of the preferred location of the called party.

25. A VoIP network element for providing a VoIP-based communication service in VoIP-based system which network element includes as a feature
a protocol enabling an availability of a presence information of at least a communication means of a called party,
characterized in that the VoIP network element is arranged to
perform lookup operations initiated by a communication device of a caller party and concerning the called party and in which lookup operations is applied data provided by a protocol enabling a presence information availability of at least the communication means of the called party,
define a data of the called party to be returned and
return the defined data of the called party to the communication device of the caller party.

26. VoIP network element according to claim 25, characterized in that it includes as a feature a determination of a cost of communication in order to decide the cost optimal routing for the communication between the caller and the called party.
